(19) United States
(12) Patent Application Publication
(10) Pub. No.: US 2010/0186533 A1
(43) Pub. Date: Jul. 29, 2010

(54) UPTURNING DEVICE FOR OPERATION LEVER MOUNTING BODY OF WORK MACHINE

(75) Inventors: Eiji Akahane, Tokyo (JP); Tetsuji Takaoka, Tokyo (JP); Teruyuki Yamada, Hyogo (JP)

Correspondence Address: MCDERMOTT WILL & EMERY LLP, 600 13TH STREET, N.W., WASHINGTON, DC, 20005-3096, US

(73) Assignee: Caterpillar Japan Ltd., Tokyo (JP)

(21) Appl. No.: 12/677,620

(22) PCT Filed: Apr. 10, 2008
(86) PCT No.: PCT/JP2008/057063

§ 371 Date: Mar. 11, 2010

(30) Foreign Application Priority Data
Sep. 14, 2007 (JP) 2007-238933

(51) Int. Cl. E02F 9/24; G05G 11/00

(52) U.S. Cl. 74/483 R

(57) ABSTRACT

A console upturnably provided adjacent to an access area for gaining access to a seat installed in a work machine is provided with a release lever, to disengage a console securing locking portion and enabling the console to be upturned. The console has a hydraulic locking lever. Shifting the hydraulic locking lever to an opening position unblocks the access area, and performs a locking function to disable operation of the work machine; shifting the hydraulic locking lever to a blocking position to block the access area performs an unlocking function, thereby enabling operation of the work machine. Provided in relation to the release lever is a lever operation restraining mechanism that disengages the release lever and enables the console to be upturned when the hydraulic locking lever is in the opening position, and prevent upturning operation when the hydraulic locking lever is in the blocking position.

### RELATED APPLICATIONS

This application is the U.S. National Phase under 35 U.S.C. §371 of International Application No. PCT/JP2008/057063, filed on Apr. 10, 2008, which claims the benefit of Japanese Application No. 2007-238933, filed on Sep. 14, 2007, the disclosures of which Applications are incorporated by reference herein.

### TECHNICAL FIELD

The present invention relates to an upturning device for an operation lever mounting body of a work machine. To be more specific, the present invention relates to an upturning device for upturning an operation lever mounting body that is upturnably provided adjacent to an access area for gaining access to a seat installed in a work machine.

### BACKGROUND OF THE INVENTION

FIG. 8 illustrates a hydraulic excavator, which is a work machine 11 and includes a lower structure 12, an upper structure 13, a cab 14, and a front work equipment 15. The cab 14 and the front work equipment 15 are mounted on the upper structure 13, which is rotatably mounted on the lower structure 12. A seat for an operator to sit in is installed inside the cab 14.

FIG. 9 illustrates the cab 14 of the work machine 11. A work machine 11 of this type is typically provided with a hydraulic locking lever 16 of a hydraulic locking mechanism for shutting off the hydraulic circuit. The hydraulic locking lever 16 is mounted on the console 19 provided adjacent to an access area 18 for gaining access to a seat 17, and serves to prevent, by shutting off the hydraulic circuit, inadvertent movement of the work machine 11 when the operator is getting into or out of the operator station of the cab 14 while the engine is running. The hydraulic locking lever 16 is an on/off switching lever adapted to disable or enable operation of the work machine 11, depending on whether the hydraulic locking lever 16 is in an opening position for unblocking the access area 18, i.e. the position shown by solid line, or a blocking position for blocking the access area 18, i.e. the position shown by two-dot chain line. To be more specific, shifting the hydraulic locking lever 16 to the unblocking position performs a locking function so as to disable operation of the work machine 11, and shifting the hydraulic locking lever 16 to the blocking position performs an unlocking function, thereby enabling operation of the work machine 11.

Hydraulic locking mechanisms of this type are widely used, examples of which include a device provided with a boarding/alighting gate and adapted to open the boarding/alighting gate when the hydraulic circuit is shut. (e.g. see Japanese Utility Model Publication No. 6-57964 (p 1, and FIG. 1) (“JP '964”)).

The device disclosed in JP '964 mentioned above is used not only when entering or exiting the operator station but also for performing the locking function to prevent inadvertent movement of the work machine 11 when the work machine 11 is at a standstill.

Furthermore, for a compact revolving machine, the travel operation lever is provided in front of the operator's seat, making the distance shorter between the travel operation lever and a front equipment operation lever that serves to operate the front work equipment 15 and is mounted on the console provided adjacent to the access area to the seat. As the short distance between the travel operation lever and the front operation lever makes entering or exiting from the operator station difficult, a measure to enlarge the passage in front of the console adjacent to the access area has been invented. This is achieved by upturning the console adjacent to the access area by operating a console upturning lever provided at the lower part of the console. According to this console upturning method, the console box is secured at an in-use position or an upturned position by means of a single extension spring (e.g. see Japanese Laid-open Patent Publication No. 2000-179005 (pp 4 and 5, and FIG. 4) (“JP '005”)).

According to the invention disclosed in JP '964, the distance from the travel operation lever is not increased. On the other hand, the invention disclosed in JP '005 presents the problem of not being easy-to-use, because the console becomes upturned even when the work machine is temporarily stopped. In order to mitigate these problems, there have been inventions that entail moving a gate bar to the access area opening position in conjunction with movement of the console box to the upturning position (e.g. Japanese Laid-open Patent Publication No. 2000-328605 (p 1, and FIGS. 1 and 2) (“JP '605”)).

The invention disclosed in JP '605 has a structure such that operating an upturning lever automatically pivots the gate bar to the opening position. However, a hydraulic locking switch, which is the key component of this structure, functions only when the gate bar starts to pivot. This means that hydraulic locking becomes effective during the course of upturning the console, in other words only after the console upturning process begins.

The invention disclosed in JP '964 is unable to ensure a sufficiently large access passage.

The invention disclosed in JP '005 is not easy to use, because the console becomes upturned even when the work machine is temporarily stopped. Furthermore, the console upturning lever projects into the access area and is not easy to operate, because, whenever operating the console upturning lever, the operator has to extend his arm beyond the front equipment operation lever, resulting in the possibility of accidentally hitting the front equipment operation lever with him arm.

The invention disclosed in JP '605 has a structure wherein hydraulic locking becomes effective during the course of upturning the console, in other words only after the console upturning process begins, and is therefore difficult to ensure the locking function that is supposed to take place has properly been carried out.

Other examples of conventionally proposed structures include one that uses a hook. According to this structure, it is possible to operate a locking lever even when the console is upturned. However, it has such structural problems of a nature that the operator is likely to notice an operation mistake only when he attempts to lower the console and finds it impossible to do so. Furthermore, two limit switches are required.

Another example of conventionally proposed structures includes a hydraulic locking lever 16 that serves to activate hydraulic locking at the first stage of operation of the hydraulic locking lever 16 and upturn the console at the second stage of the operation. However, the hydraulic locking lever 16 of a two-stage operation type presents the possibility of pulling the hydraulic locking lever 16 forcefully may cause the console to be upturned inadvertently.

In order to solve the above problems, an object of the invention is to provide an upturning device for an operation lever mounting body of a work machine that is capable of ensuring that the work machine is maintained in an inoperable state when the operation lever mounting body is upturned.

### SUMMARY OF THE INVENTION

The present invention relates to an upturning device for an operation lever mounting body of a work machine. The upturning device includes an operation lever mounting body upturnably provided adjacent to an access area for gaining access to a seat installed in a work machine; a release lever that is provided on the operation lever mounting body and serves to enable the operation lever mounting body to be upturned; a locking lever provided on the operation lever mounting body and adapted to be shifted back and forth between an opening position for unblocking the access area and a blocking position for blocking the access area so that shifting the locking lever to the opening position performs a locking function so as to disable operation of the work machine and that shifting the locking lever to the blocking position performs an unlocking function, thereby enabling operation of the work machine; and a lever operation restraining mechanism adapted to disengage the release lever when the locking lever is in the opening position, thereby enabling upturning operation, and restrain the release lever when the locking lever is in the blocking position, thereby preventing upturning operation.

According to the present invention, the lever operation restraining of the operation lever mounting body of the work machine according to the above of the present invention is a console that houses therein an operation control valve, and the release lever projects upward from the console.

According to the present invention, the lever operation restraining mechanism of the upturning device for the operation lever mounting body of the work machine according to the above includes a restraining member. The restraining member is adapted to restrain the release lever and thereby prevent upturning operation when the locking lever is in the blocking position. The restraining member is also adapted to prevent the locking lever from performing the unlocking function when the release lever is operated to upturn the operation lever mounting body in the state where the locking lever is in the opening position.

According to the present invention, the upturning device for the operation lever mounting body includes a mounting plate provided as a part of the operation lever mounting body, and a base end portion of the locking lever is pivotally supported and connected to the mounting plate by a locking lever shaft portion. Furthermore, the lever operation restraining mechanism includes an elongated hole, an interlocking lever, a connecting shaft portion, and a spring. The elongated hole is formed at the base end portion of the locking lever so as to extend towards and away from the locking lever shaft portion. The interlocking lever is pivotally supported and connected at the middle portion thereof to the mounting plate by an interlocking lever shaft portion. The restraining member is attached to an end of the interlocking lever. The connecting shaft portion is attached to the other end of the interlocking lever and slidably fitted in the elongated hole of the locking lever so that the connecting shaft portion is able to move back and forth across an imaginary line extending from the locking lever shaft portion to the interlocking lever shaft portion. The spring serves to bias the connecting shaft portion so that, when the connecting shaft portion is on one side of the imaginary line extending from the locking lever shaft portion to the interlocking lever shaft portion, the spring applies a force in the direction towards the one side of the imaginary line, and applies a force in the direction towards the other side of the imaginary line when the connecting shaft portion is on the other side of the imaginary line.

According to the invention, the lever operation restraining mechanism is adapted to disengage the release lever when the locking lever is in the opening position, thereby enabling upturning operation, and restrain the release lever when the locking lever is in the blocking position, thereby preventing upturning operation. Therefore, the lever operation restraining mechanism makes it impossible to operate the release lever to upturn the operation lever mounting body, unless the work machine is put into an inoperable state by shifting the locking lever to the opening position. As a result, the operation lever mounting body can be upturned only when the work machine is reliably maintained in the inoperable state.

According to another aspect of the invention, the release lever, which is provided on the console and projects upward therefrom, is easy to operate and facilitates upturning of the console.

According to a further aspect of the invention, in the state where the release lever has been operated to enable upturning of the operation lever mounting body when the locking lever is in the opening position, the restraining member prevents the locking lever from being operated to perform the unlocking function and thereby ensures reliable prevention of inadvertent activation of the work machine when the operation lever mounting body is in the upturned state.

According to the invention, by means of the same spring, it is possible to bias the interlocking lever of the lever operation restraining mechanism so that the release lever is maintained in such a state as to enable or prevent upturning of the operation lever mounting body, as well as bias the locking lever towards the opening position or the blocking position. Thus, the invention provides a simple structure.

### BRIEF DESCRIPTION OF THE DRAWINGS

FIG. 1 is a front view of an upturning device for an operation lever mounting body of a work machine according to an embodiment of the present invention.

FIG. 2 is a front view of the aforementioned upturning device in the state where a release lever thereof is in an engaged position.

FIG. 3 is a front view of the upturning device in the state where a hydraulic locking lever thereof is in an unlocking position.

FIG. 4 is a perspective view of the upturning device in the state where the release lever is in an engaged position.

FIG. 5 is a perspective view of an upturning device for an operation lever mounting body of a work machine according to another embodiment of the present invention.

FIG. 6 is a front view of the upturning device of FIG. 5 in the state where the console is in an upturned position.

FIG. 7 is a back view of the upturning device of FIG. 5 in the state where the console is in the upturned position.

FIG. 8 is a side view of the work machine.

FIG. 9 is a perspective view of the interior of the cab of the work machine.

### DETAILED DESCRIPTION OF THE INVENTION

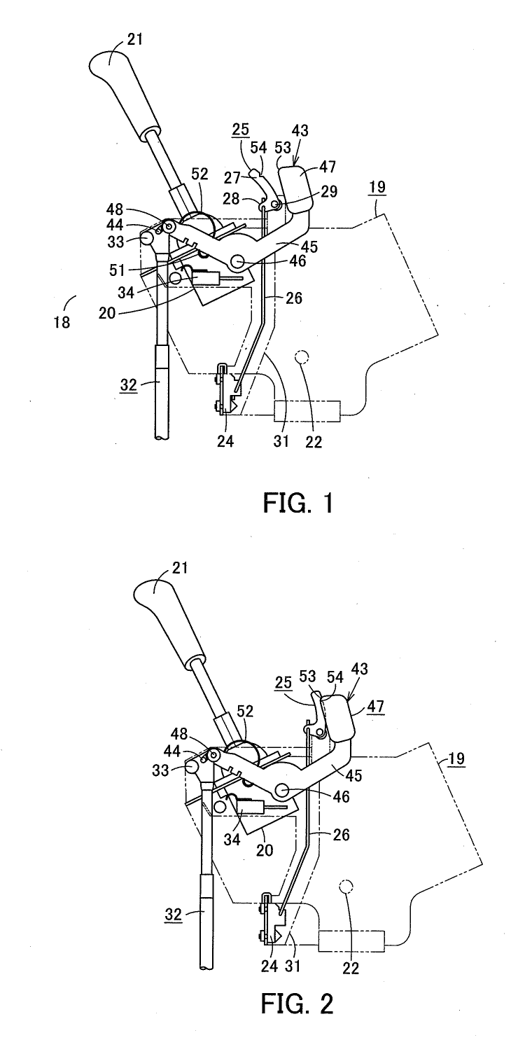

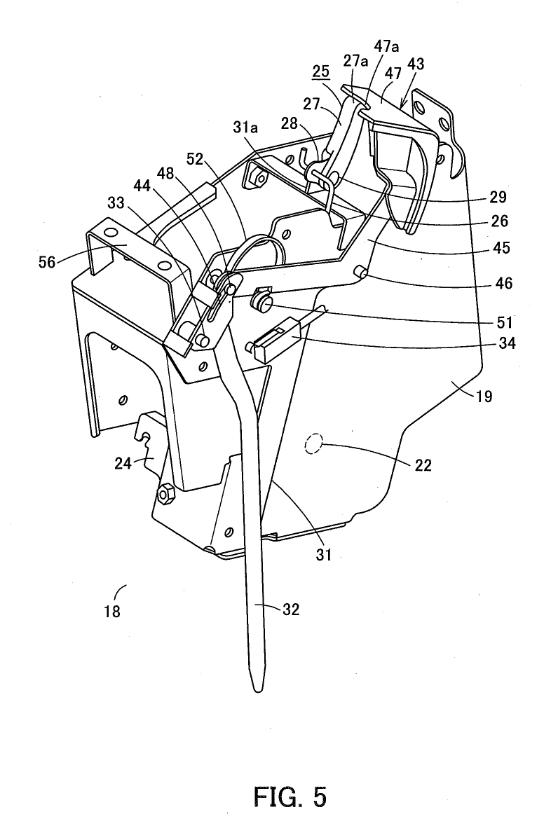

Next, the present invention is explained in detail hereunder, referring to an embodiment thereof shown in FIGS. 1 to 4 and another embodiment thereof shown in FIGS. 5 to 7.

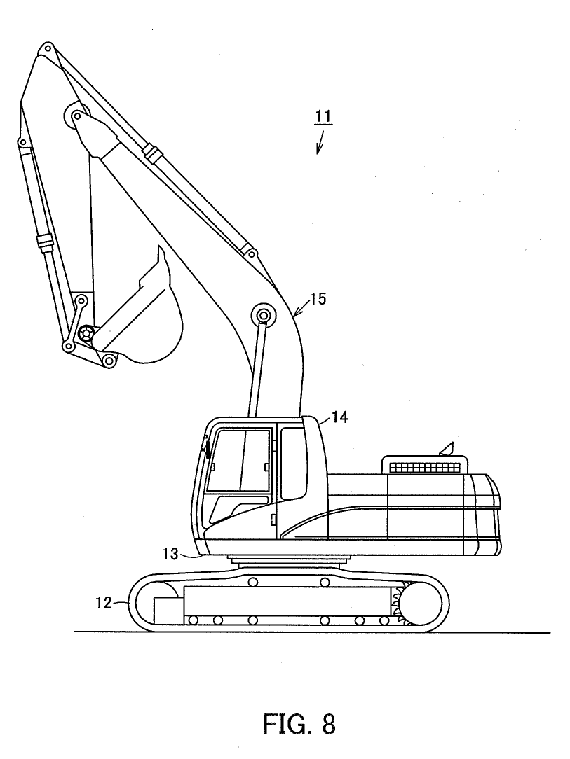

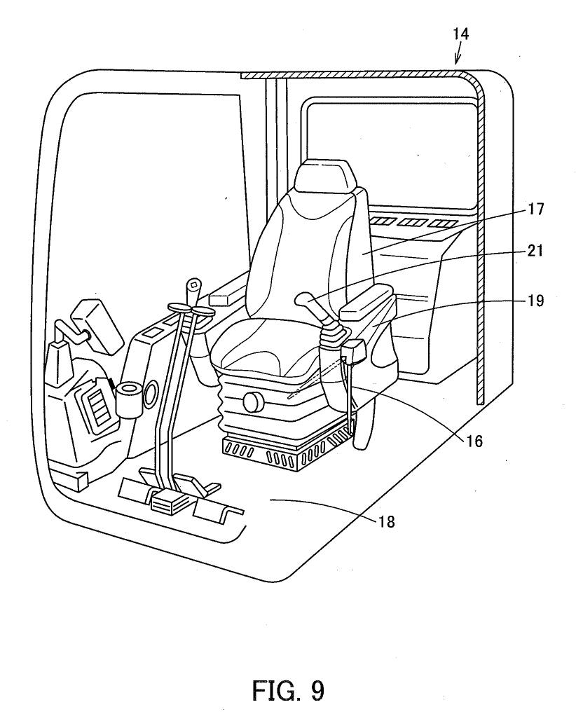

First of all, an upturning device for an operation lever mounting body of a work machine according to an embodiment of the present invention shown in FIGS. 1 to 4 is explained. As shown in FIGS. 8 and 9, a console 19 serving as an operation lever mounting body is provided at each lateral side of a seat 17 of a work machine 11. Each console 19 houses an operation control valve 20 therein and is also provided with an operation lever 21 for operating a front work equipment 15. Of the two consoles 19, the console 19 that is located at the side adjacent to the access area 18 is capable of pivoting around a shaft 22 as shown in FIG. 1. In the explanation hereunder, unless otherwise specified, “the console 19” refers to the console 19 that is located at the side adjacent to the access area 18. The console 19 is also provided with a biasing means, such as a spring (not shown in the drawings), so that the console 19 can be upturned in the clockwise direction as viewed in FIG. 1. By upturning the console 19, the operation lever 21 can be positioned away from the access area 18.

Provided below the operation lever of the console 19 is a console securing locking portion 24, which is capable of engaging with and disengaging from a catching portion (not shown in the drawings). The catching portion is provided on the floor surface at the base of the seat. The console securing locking portion 24 has an unlocking portion (not shown in the drawings). The unlocking portion of the console securing locking portion 24 is connected through a rod 26 to a release lever 25, which projects upward from the console 19.

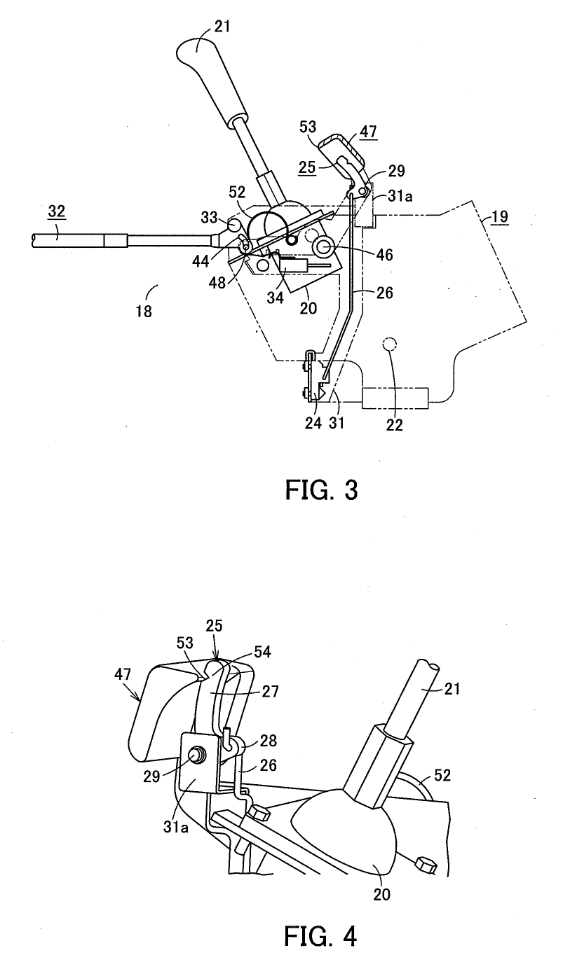

The release lever 25 is bent into an L-like shape including an operating portion 27 and a rod insertion portion 28. A mounting plate 31 is integrally formed with a side face of the console 19, and a shaft supporting plate portion 31a (shown in FIGS. 3 and 4) is provided at the upper part of the mounting plate 31. The portion at which the release lever 25 is bent is pivotally supported and connected to the shaft supporting plate portion 31a of the mounting plate 31 by a shaft 29. As a result of the operator pulling the operating portion 27 of the release lever 25 to the right as viewed in FIG. 1, a console-unlocking function for upturning the console 19 is activated so that the console securing locking portion 24 becomes disengaged from the catching portion (not shown) on the floor surface at the base of the seat, enabling the console 19 to be upturned.

By means of a locking lever shaft portion 33, the base end portion of a hydraulic locking lever 32, which serves as a locking lever, is pivotally supported and connected to the mounting plate 31, which is provided integrally with the side face of the console 19. The hydraulic locking lever 32 is adapted to disable or enable operation of the work machine 11 depending on whether the hydraulic locking lever 32 is in an opening position for unblocking the access area 18, i.e. the position shown in FIG. 1, or a blocking position for blocking the access area 18, i.e. the position shown in FIG. 3. To be more specific, shifting the hydraulic locking lever 32 to the opening position performs the locking function so as to disable operation of the work machine 11, and shifting the hydraulic locking lever 32 to the blocking position performs the unlocking function, thereby enabling operation of the work machine 11. This locking/unlocking function is activated by means of a limit switch 34 provided on the mounting plate 31.

For example, a hydraulic locking valve (not shown in the drawings) of an electromagnetic switching type may be disposed on a pilot primary pressure line to the operation control valve 20. If such is the case, when the hydraulic locking lever 32 is shifted to the opening position shown in FIG. 1, a controller (not shown in the drawings) cuts off the pilot primary pressure by switching the hydraulic locking valve to the locking position upon receiving from the limit switch 34 a signal indicating that the lever 32 is in the opening position. As a result, the work machine 11 remains inoperable even if the operation lever 21 is operated. When the hydraulic locking lever 32 is shifted to the blocking position shown in FIG. 3, the controller enables operation of the work machine 11 by switching the hydraulic locking valve to the unlocking position so that the pilot primary pressure is fed to the operation control valve 20.

Furthermore, a lever operation restraining mechanism 43 is provided to disengage or restrain the release lever 25. When the hydraulic locking lever 32 is in the opening position shown in FIG. 1, the lever operation restraining mechanism 43 disengages the release lever 25, thereby enabling the release lever 25 to be operated to upturn the console 19. When the hydraulic locking lever 32 is in the blocking position shown in FIG. 3, the lever operation restraining mechanism 43 restrains the release lever 25 to prevent upturning operation for upturning the console 19.

The lever operation restraining mechanism 43 includes an elongated hole 44, an interlocking lever 45, an interlocking lever shaft portion 46, a restraining member 47, and a connecting shaft portion 48. The elongated hole 44 extending towards and away from the locking lever shaft portion 33 is formed in the base end portion of the hydraulic locking lever 32. The interlocking lever 45 is pivotally supported and connected at the middle portion thereof to the mounting plate 31 by the interlocking lever shaft portion 46. The restraining member 47 is attached to an end of the interlocking lever 45. The connecting shaft portion 48 is attached to the other end of the interlocking lever 45 and slidably fitted in the elongated hole 44 of the hydraulic locking lever 32. The elongated hole 44 of the hydraulic locking lever 32 extends in such a direction that the connecting shaft portion 48 fitted therein is able to move towards or away from the locking lever shaft portion 33, back and forth across an imaginary line extending from the locking lever shaft portion 33 to the interlocking lever shaft portion 46.

A spring 52 formed of a strip-like plate curved into an arc is provided between a spring mounting shaft portion 51, which is immovably attached to the mounting plate 31, and the aforementioned connecting shaft portion 48. The spring 52 serves to apply a constant upward force to the connecting shaft portion 48 when the connecting shaft portion 48 is located above the aforementioned imaginary line extending from the locking lever shaft portion 33 to the interlocking lever shaft portion 46 as shown in FIG. 1, and apply a constant downward force to the connecting shaft portion 48 when the connecting shaft portion 48 is located below the imaginary line extending from the locking lever shaft portion 33 to the interlocking lever shaft portion 46 as shown in FIG. 3.

Being thus biased by the spring 52, the hydraulic locking lever 32 and the interlocking lever 45 stop each other at either of two intersection points at which the movement locus of the maximum diameter portion of the elongated hole 44 centering around the locking lever shaft portion 33 of the hydraulic locking lever 32 and the movement locus of the connecting shaft portion 48 centering around the interlocking lever shaft portion 46 of the interlocking lever 45 intersect each other.

To be more specific, when the hydraulic locking lever is in the opening position shown in FIG. 1, the hydraulic locking lever 32 and the connecting shaft portion 48 are stopped at the upper intersection point at which the movement locus of the maximum diameter portion of the elongated hole 44 and the movement locus of the connecting shaft portion 48 intersect each other. When the hydraulic locking lever 32 is in the blocking position shown in FIG. 3, the hydraulic locking lever 32 and the connecting shaft portion 48 are stopped at the lower intersection point at which the movement locus of the maximum diameter portion of the elongated hole 44 and the movement locus of the connecting shaft portion 48 intersect each other. The hydraulic locking lever 32 and the connecting shaft portion 48 are pivoted between these two stopping locations.

The restraining member 47 of the lever operation restraining mechanism 43 is so formed as to restrain the release lever 25 to prevent upturning operation for upturning the console 19 when the hydraulic locking lever 32 is in the blocking position shown in FIG. 3, and, when the release lever 25 is operated for upturning operation in the state where the hydraulic locking lever 32 is in the opening position shown in FIG. 2, engage the release lever so as to prevent the hydraulic locking lever 32 from performing the unlocking function.

To be more specific, as shown in FIG. 3, a protruding portion 53 is formed at the upper part of the restraining member 47. As shown in FIGS. 1 and 2, the release lever 25 is provided, at the side thereof facing the restraining member 47, with a notched portion 54 for engaging with the protruding portion 53 of the restraining member 47.

As described above, in the inoperable state of the work machine shown in FIG. 1, i.e. in the state where the hydraulic locking lever 32 is in the lowered position to perform hydraulic locking, the release lever 25 can be operated to enable the console 19 to be upturned. To be more specific, when the hydraulic locking lever 32 is shifted to the opening position, in other words the non-blocking position as shown in FIG. 1(the hydraulic locking mode), the release lever 25 becomes exposed so that the release lever 25 can be operated as shown in FIG. 2 to enable upturning of the console.

On the other hand, in the operable state of the work machine shown in FIG. 3, i.e. in the state where the hydraulic locking lever 32 is in the elevated position and thereby releases the hydraulic locking, the restraining member 47 of the lever operation restraining mechanism 43 prevents the release lever 25 from being operated to upturn the console 19. To achieve this, the release lever 25, which serves to disengage the console securing locking portion 24, is provided at such a location that the release lever 25 is concealed in the restraining member 47 when the hydraulic locking lever 32 is in the blocking position.

In the console upturning mode shown in FIG. 2, the restraining member 47 of the interlocking lever 45 is engaged with the release lever 25. Therefore, even if the operator tries to operate the hydraulic locking lever 32 to perform the unlocking function, the engagement of the protruding portion 53 of the restraining member 47 with the notched portion 54 of the release lever 25 prevents the hydraulic locking lever 32 from being operated to perform the unlocking function.

Next, the functions of this embodiment are explained hereunder.

When the hydraulic locking lever 32 is in the opening position, in other words the non-blocking position, as shown in FIG. 1 with the release lever 25 exposed, pulling the release lever 25 towards the restraining member 47 disengages the console securing locking portion 24, thereby enabling the console 19 to be upturned.

At that time, as shown in FIG. 2, the release lever 25 moves to the position where the notched portion 54 formed in the release lever 25 interlockingly engages with the protruding portion 53 of the restraining member 47. Thus, the release lever 25 engages with the restraining member 47.

In other words, should the operator try to elevate the hydraulic locking lever 32 to its blocking position when the console 19 is in the upturned state, the interlocking engagement of the protruding portion 53 and the notched portion 54 makes it impossible to shift the hydraulic locking lever 32.

When the console 19 is pushed down so that the console securing locking portion 24 engages with the catching portion (not shown) on the floor surface at the base of the seat and thereby secures the console 19, the release lever 25 returns to the initial position shown in FIG. 1. As a result, it becomes possible to operate the hydraulic locking lever 32 to the blocking position shown in FIG. 3.

In the operable state of the work machine, wherein the hydraulic locking lever 32 is in the elevated position as shown in FIG. 3 to release the hydraulic locking so that the work machine can be operated, the restraining member 47 of the lever operation restraining mechanism 43 completely covers the release lever 25 and thereby makes it impossible to operate the release lever 25. Therefore, it is impossible to operate the release lever 25 to enable upturning of the console 19.

Next, the effects of this embodiment are explained hereunder.

When the hydraulic locking lever 32 is in the opening position shown in FIG. 1, the lever operation restraining mechanism 43 disengages the release lever 25, thereby enabling the release lever 25 to be operated to upturn the console 19. When the hydraulic locking lever 32 is in the blocking position shown in FIG. 3, the lever operation restraining mechanism 43 restrains the release lever 25 to prevent upturning operation for upturning the console 19. Therefore, it is not possible to operate the release lever 25 to upturn the console, unless the work machine is put into the inoperable state by shifting the hydraulic locking lever 32 to the non-blocking position, i.e. the opening position. In other words, the lever operation restraining mechanism 43 enables the console 19 to be upturned only when the work machine 11 is reliably maintained in the inoperable state.

The release lever 25, which is provided on the console 19 and projects upward therefrom, is easy to operate and facilitates upturning of the console 19.

In the state where the release lever 25 has been operated as shown in FIG. 2 to enable upturning of the console 19 when the hydraulic locking lever 32 is in the opening position, the restraining member 47 prevents the hydraulic locking lever 32 from being operated to perform the unlocking function and thereby ensures reliable prevention of inadvertent activation of the work machine when the console 19 is in the upturned state.

As shown in FIGS. 1 and 3, by means of the same spring 52, it is possible to bias the interlocking lever 45 of the lever operation restraining mechanism 43 so that the release lever 25 is maintained in such a state as to enable or prevent upturning of the console 19, as well as bias the hydraulic locking lever 32 towards the opening position or the blocking position. Thus, the embodiment described above provides a simple structure.

Next, FIGS. 5 to 7 show an upturning device for an operation lever mounting body of a work machine according to another embodiment of the present invention.

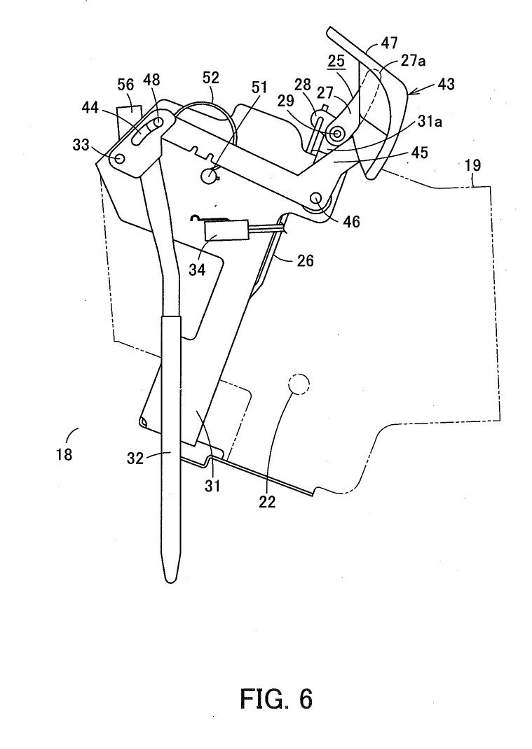

A console 19 serving as an operation lever mounting body is provided at each lateral side of the seat. Each console 19 houses an operation control valve (not shown in the drawings) therein and is also provided with an operation lever (not shown in the drawings) for operating a front work equipment 15. Of the two consoles 19, the console 19 that is located at the side adjacent to the access area 18 is capable of pivoting around a shaft 22 as shown in FIG. 6. In the explanation hereunder, unless otherwise specified, “the console 19” refers to the console 19 that is located at the side adjacent to the access area 18. The console 19 is also provided with a biasing means, such as a spring (not shown in the drawings), so that the console 19 can be upturned in the clockwise direction as viewed in FIG. 6. By upturning the console 19, the operation lever (not shown in the drawings) can be positioned away from the access area 18. A grip 56 for pivoting the console 19 is provided on top of the front part of the console 19.

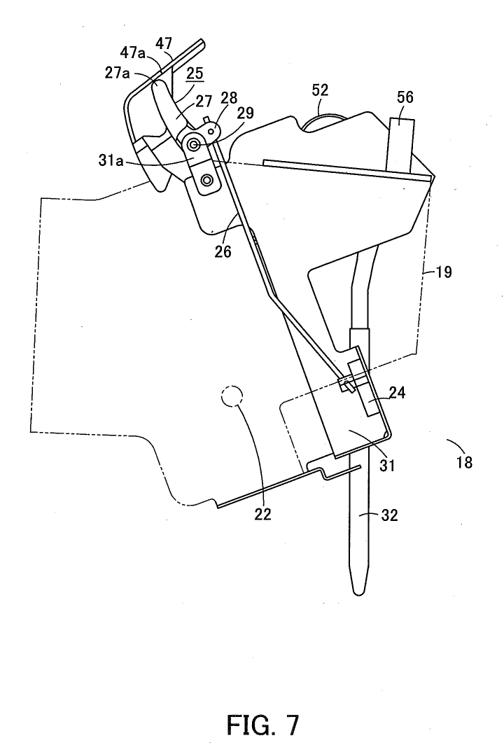

As shown in FIGS. 5 and 7, a console securing locking portion 24 is provided at the lower part of the console 19. The console securing locking portion 24 is capable of engaging with and disengaging from a catching portion (not shown in the drawings) that is provided on the floor surface at the base of the seat. The console securing locking portion 24 has an unlocking portion (not shown in the drawings). The unlocking portion of the console securing locking portion 24 is connected through a rod 26 to a release lever 25, which projects upward from the console 19.

The release lever 25 is bent into an L-like shape including an operating portion 27 and a rod insertion portion 28. A mounting plate 31 is integrally formed with a side face of the console 19, and a shaft supporting plate portion 31a is provided at the upper part of the mounting plate 31. The portion at which the release lever 25 is bent is pivotally supported and connected to the shaft supporting plate portion 31a of the mounting plate 31 by a shaft 29. As a result of the operator pulling the operating portion 27 of the release lever 25 to the right as illustrated in FIG. 6, console-unlocking operation for upturning the console 19 is performed so that the console securing locking portion 24 becomes disengaged from the catching portion (not shown) on the floor surface at the base of the seat, enabling the console 19 to be upturned.

By means of a locking lever shaft portion 33, the base end portion of a hydraulic locking lever 32, which serves as a locking lever, is pivotally supported and connected to the mounting plate 31, which is provided integrally with the side face of the console 19. The hydraulic locking lever 32 is adapted to disable or enable operation of the work machine 11, depending on whether the hydraulic locking lever 32 is in the opening position for unblocking the access area 18 or the blocking position for blocking the access area 18. To be more specific, shifting the hydraulic locking lever 32 to the opening position performs the locking function so as to disable operation of the work machine 11, and shifting the hydraulic locking lever 32 to the blocking position performs the unlocking function, thereby enabling operation of the work machine 11. This locking/unlocking operation is activated by means of a limit switch 34 provided on the mounting plate 31. As the hydraulic locking valve of an electromagnetic switching type connected to the limit switch 34 has the same configuration as that shown in FIG. 1, its explanation is omitted.

Furthermore, a lever operation restraining mechanism 43 is provided to disengage or restrain the release lever 25. When the hydraulic locking lever 32 is in the opening position, the lever operation restraining mechanism 43 disengages the release lever 25, thereby enabling the release lever 25 to be operated to upturn the console 19. When the hydraulic locking lever 32 is in the blocking position, the lever operation restraining mechanism 43 restrains the release lever 25 to prevent upturning operation for upturning the console 19.

The lever operation restraining mechanism 43 includes an elongated hole 44, an interlocking lever 45, an interlocking lever shaft portion 46, a restraining member 47, and a connecting shaft portion 48. The elongated hole is formed in the base end portion of the hydraulic locking lever 32 so as to extend towards and away from the locking lever shaft portion 33. The interlocking lever 45 is pivotally supported and connected at the middle portion thereof to the mounting plate 31 by the interlocking lever shaft portion 46. The restraining member 47 is attached to an end of the interlocking lever 45. The connecting shaft portion 48 is attached to the other end of the interlocking lever 45 and slidably fitted in the elongated hole 44 of the hydraulic locking lever 32. The elongated hole 44 of the hydraulic locking lever 32 extends in such a direction that the connecting shaft portion 48 fitted therein is able to move towards or away from the locking lever shaft portion 33, back and forth across an imaginary line extending from the locking lever shaft portion 33 to the interlocking lever shaft portion 46.

A spring 52 formed of a strip-like plate curved into an arc is provided between a spring mounting shaft portion 51, which is immovably attached to the mounting plate 31, and the aforementioned connecting shaft portion 48. The spring 52 serves to apply a constant upward force to the connecting shaft portion 48 when the connecting shaft portion 48 is located above the aforementioned imaginary line extending from the locking lever shaft portion 33 to the interlocking lever shaft portion 46 as shown in FIG. 6, and apply a constant downward force to the connecting shaft portion 48 when the connecting shaft portion 48 is located below the imaginary line extending from the locking lever shaft portion 33 to the interlocking lever shaft portion 46.

Stopper means (not shown in the drawings) are provided in order to respectively stop the hydraulic locking lever 32 and the interlocking lever 45, which are thus biased by the spring 52. The stopper means for the hydraulic locking lever 32 stops the hydraulic locking lever 32 at the opening position or blocking position thereof so that the hydraulic locking lever 32 pivots between these two positions, and the stopper means for the interlocking lever 45 stops the interlocking lever 45 at the opening position or blocking position thereof so that the interlocking lever 45 pivots therebetween.

The restraining member 47 of the lever operation restraining mechanism 43 is so formed as to restrain the release lever 25 to prevent upturning operation for upturning the console 19 when the hydraulic locking lever 32 is in the blocking position, and, when the release lever 25 is operated to upturn the console in the state where the hydraulic locking lever 32 is in the opening position as shown in FIGS. 6 and 7, engage with the release lever 25 so as to prevent the hydraulic locking lever 32 from performing the unlocking function.

To be more specific, as shown in FIG. 5, a cutout portion 47a is formed at the front end of the restraining member 47. A catching portion 27a is formed at the upper end of the operating portion 27 of the release lever 25 and adapted to be positioned in the cutout portion 47a so as to abut against the inner surface of the restraining member 47.

As described above, in the inoperable state of the work machine shown in FIGS. 5 and 6, i.e. in the state where the hydraulic locking lever 32 is in the lowered position to perform hydraulic locking, the release lever 25 can be operated to enable the console 19 to be upturned. To be more specific, when the hydraulic locking lever 32 is shifted to the opening position, in other words the non-blocking position (the hydraulic locking mode), the release lever 25 becomes exposed from the cutout portion 47a and is thereby enabled to be operated to upturn the console.

On the other hand, in the operable state of the work machine, i.e. in the state where the hydraulic locking lever 32 is in the elevated position and thereby releases the hydraulic locking, the restraining member 47 of the lever operation restraining mechanism 43 prevents the release lever 25 from being operated to upturn the console 19. To achieve this, the release lever 25, which serves to disengage the console securing locking portion 24, is provided at such a location that the release lever 25 is concealed in the restraining member 47 when the hydraulic locking lever 32 is in the blocking position.

In the console upturning mode shown in FIG. 6, the restraining member 47 of the interlocking lever 45 abuts against the release lever 25. Therefore, even if the operator tries to operate the hydraulic locking lever 32 to release the hydraulic locking, the catching portion 27a of the operating portion 27 of the release lever 25, which is positioned inside the cutout portion 47a, abuts against the inner surface of the restraining member 47 and thereby prevents the hydraulic locking lever 32 from being operated to perform the unlocking function.

Next, the functions of the embodiment shown in FIGS. 5 to 7 are explained hereunder.

When the hydraulic locking lever 32 is in the opening position, in other words the non-blocking position with the release lever 25 exposed from the cutout portion 47a, pulling the release lever 25 towards the restraining member disengages the console securing locking portion 24, thereby enabling the console 19 to be upturned.

At that time, the catching portion 27a of the operating portion 27 of the release lever 25 is positioned in the cutout portion 47a and abuts against the inner surface of the restraining member 47. In other words, should the operator try to elevate the hydraulic locking lever 32 to its blocking position when the console 19 is in the upturned state, the abutting of the catching portion 27a and the inner surface of the restraining member 47 makes it impossible to shift the hydraulic locking lever 32.

When the console 19 is pushed down so that the console securing locking portion 24 engages with the catching portion (not shown) on the floor surface at the base of the seat, the release lever 25 returns to the initial position, in the state that it is exposed from the cutout portion 47a. As a result, it becomes possible to operate the hydraulic locking lever 32 to the blocking position.

In the operable state of the work machine, wherein the hydraulic locking lever 32 is in the elevated position and thereby releases the hydraulic locking so that the work machine can be operated, the restraining member 47 of the lever operation restraining mechanism 43 completely covers the release lever 25 and thereby makes it impossible to operate the release lever 25. Therefore, it is impossible to upturn the console 19 by operating the release lever 25.

According to the embodiment shown in FIGS. 5 to 7, in the state where the release lever 25 has been operated to enable upturning of the console 19 when the hydraulic locking lever 32 is in the opening position, the catching portion 27a of the operating portion 27, which is positioned in the cutout portion 47a, reliably abuts against the inner surface of the restraining member 47 and thereby prevents the hydraulic locking lever 32 from being shifted to the blocking position to perform the unlocking function. As a result, the embodiment ensures reliable prevention of inadvertent activation of the work machine when the console 19 is in the upturned state. Furthermore, as the effects achieved by the embodiment shown in FIGS. 1 to 4 can also be achieved by this embodiment, the explanation of such effects is omitted herein.

The present invention is applicable to any work machine, such as a hydraulic excavator, that is provided with an upturnable console installed at an access area for gaining access to a seat, including a work machine that is not provided with a cab (an operator station).

1. An upturning device for an operation lever mounting body of a work machine, the upturning device comprising:
an operation lever mounting body upturnably provided adjacent to an access area for gaining access to a seat installed in a work machine;
a release lever that is provided on the operation lever mounting body and serves to enable the operation lever mounting body to be upturned;
a locking lever provided on the operation lever mounting body and adapted to be shifted back and forth between an opening position for unblocking the access area and a blocking position for blocking the access area so that shifting the locking lever to the opening position performs a locking function so as to disable operation of the work machine and that shifting the locking lever to the blocking position performs an unlocking function, thereby enabling operation of the work machine; and
a lever operation restraining mechanism adapted to disengage the release lever when the locking lever is in the opening position, thereby enabling upturning operation, and restrain the release lever when the locking lever is in the blocking position, thereby preventing upturning operation.

2. An upturning device for an operation lever mounting body of a work machine as claimed in claim 1, wherein:
the operation lever mounting body is a console that houses therein an operation control valve; and
the release lever projects upward from the console.

3. An upturning device for an operation lever mounting body of a work machine as claimed in claim 1, wherein:
the lever operation restraining mechanism includes a restraining member adapted to restrain the release lever and thereby prevent upturning operation when the locking lever is in the blocking position, and prevent the locking lever from performing the unlocking function when the release lever is operated to upturn the operation lever mounting body in the state where the locking lever is in the opening position.

4. An upturning device for an operation lever mounting body of a work machine as claimed in claim 3, wherein:
the operation lever mounting body is provided with a mounting plate, to which a base end portion of the locking lever is pivotally supported and connected by a locking lever shaft portion; and
the lever operation restraining mechanism includes:
an elongated hole formed at the base end portion of the locking lever so as to extend towards and away from the locking lever shaft portion;
an interlocking lever pivotally supported and connected at the middle portion thereof to the mounting plate by an interlocking lever shaft portion, with the restraining member attached to an end of the interlocking lever;
a connecting shaft portion attached to the other end of the interlocking lever and slidably fitted in the elongated hole of the locking lever so that the connecting shaft portion is able to move back and forth across an imaginary line extending from the locking lever shaft portion to the interlocking lever shaft portion; and
a spring for biasing the connecting shaft portion so that, when the connecting shaft portion is on one side of the imaginary line extending from the locking lever shaft portion to the interlocking lever shaft portion, the spring applies a force in the direction towards the one side of the imaginary line, and applies a force in the direction towards the other side of the imaginary line when the connecting shaft portion is on the other side of the imaginary line.
